(19) United States
(12) Patent Application Publication
(10) Pub. No.: US 2020/0298228 A1
(43) Pub. Date: Sep. 24, 2020

(54) APPARATUS FOR SEPARATING BIOLOGICAL MATERIALS

(71) Applicant: CELEMICS, INC., Seoul (KR)

(72) Inventors: Yu Shin JUNG, Seoul (KR); Sang Hyub LEE, Seoul (KR); Tae Hoon RYU, Seoul (KR)

(21) Appl. No.: 16/754,975

(22) PCT Filed: Oct. 16, 2018
(86) PCT No.: PCT/KR2018/012146

§ 371 Date: Apr. 9, 2020

(30) Foreign Application Priority Data
Oct. 26, 2017 (KR) 10-2017-0140064

(51) Int. Cl. B01L 3/00

(52) U.S. Cl. CPC B01L 3/5027; B01L 3/5085; B01L 2300/0816; B01L 2300/0654; B01L 2200/0652; B01L 2300/10

(57) ABSTRACT

Provided is an apparatus for separating biological materials. The apparatus includes a substrate on which a water-bearing medium is arranged, biological materials present in the water-bearing medium, an observation tool for observing the biological materials, an extraction tool for separating the biological materials from the substrate, a water supply unit for replenishing water removed from the water-bearing medium by evaporation, and a humidity control unit for measuring the temperature or humidity in a space defined between the substrate and the water supply unit.

### TECHNICAL FIELD

The present disclosure relates to an apparatus for separating biological materials, and more specifically to an apparatus for observing and separating biological materials while maintaining the biological state of the biological materials in a water-bearing medium.

### BACKGROUND ART

Highly controlled environmental conditions such as proper temperature control and supply of an optimal concentration of carbon dioxide gas (3-5%) containing an appropriate amount of water should be provided to observe changes in the state of biological materials in response to environmental changes and responses of biological materials to foreign substances in the fields of biology, medicine, and pharmacy. Since biological studies usually require observations over time, it is common to observe biological materials by microscopy. For example, biological materials may be observed by culturing a population of cells in an incubator, taking a portion of the cell population out of the incubator, and setting the cells on a microscope. Alternatively, biological materials may be observed under a microscope mounted entirely in an incubator. In attempts to eliminate this inconvenience, apparatuses for long-term continuous imaging observation and separation of various types of biological materials have been developed.

Korean Patent No. 10-0476273 discloses an apparatus for observing the state of specific cells by microscopy during long-term culture. This apparatus enables the identification of interacting cells, the observation of the cells during culture, the collection of only a cell in a particular stage, and the analysis or biochemical measurement of a gene or an expression mRNA of the cell.

Korean Patent No. 10-0745110 discloses a cell culture apparatus for continuously observing living cells by microscopy with varying temperatures of a culture medium while maintaining a uniform temperature distribution of the culture medium.

These conventional apparatuses can be used to observe biological materials present in closed containers (or culture spaces) from the outside but fail to offer suitable environmental conditions such as proper humidity and temperature conditions for maintaining the biological state of the biological materials when it is desired to observe or separate the biological materials exposed to the external environment after opening of the closed containers. Thus, the conventional apparatuses have the problems that biological materials cannot be observed and separated while maintaining their biological state.

### DETAILED DESCRIPTION OF THE INVENTION

### Means for Solving the Problems

According to one aspect of the present disclosure, there is provided an apparatus for separating biological materials, including: a substrate on which a water-bearing medium is arranged; biological materials present in the water-bearing medium; an observation tool for observing the biological materials; an extraction tool for separating the biological materials from the substrate; a water supply unit for replenishing water removed from the water-bearing medium by evaporation; and a humidity control unit for measuring the temperature or humidity in a space defined between the substrate and the water supply unit.

According to one embodiment, structures are arranged on the substrate to facilitate attachment or retention of the water-bearing medium.

According to one embodiment, the apparatus further includes a moisture removal unit for removing moisture from a space defined between the substrate and the observation tool.

According to one embodiment, the humidity control unit controls the amount of moisture generated from the water supply unit based on the measured temperature or humidity information.

According to one embodiment, the water supply unit includes a water reservoir and a moisture generator.

According to one embodiment, the water supply unit has a through-hole through which light from a light source is transmitted.

The apparatus of the present disclosure can be used to observe and separate biological materials while maintaining the biological state of the biological materials present in the water-bearing medium. The apparatus of the present disclosure is constructed such that the amount of water in the water-bearing medium is maintained constant when it is desired to observe or separate biological materials exposed to the external environment after opening of the closed container. This construction allows the biological materials to maintain their biological state.

Therefore, the apparatus of the present disclosure can effectively observe or separate biological materials without time-dependent changes in the biological state of the biological materials even when the substrate mounted with the biological materials is exposed to the external environment.

### BRIEF DESCRIPTION OF THE DRAWINGS

FIG. 1 illustrates an apparatus for separating biological materials according to one embodiment of the present disclosure.

FIG. 2 is a perspective view illustrating one embodiment of a water supply unit of the apparatus illustrated in FIG. 1.

### MODE FOR CARRYING OUT THE INVENTION

Embodiments of the present disclosure will now be described in detail with reference to the accompanying drawings. These embodiments are provided so that this disclosure will be thorough and complete, and will fully convey the scope of the present disclosure to those skilled in the art. Accordingly, the present disclosure may be embodied in many different forms and should not be construed as limited to the exemplary embodiments set forth herein. In the drawings, the dimensions, such as widths, lengths, and thicknesses, of elements may be exaggerated for clarity. The same reference numerals refer to the same elements throughout the specification. The drawings are explained from an observer's point of view. It will be understood that when an element is referred to as being “on” another element, it can be directly on the other element, or one or more intervening elements may also be present therebetween.

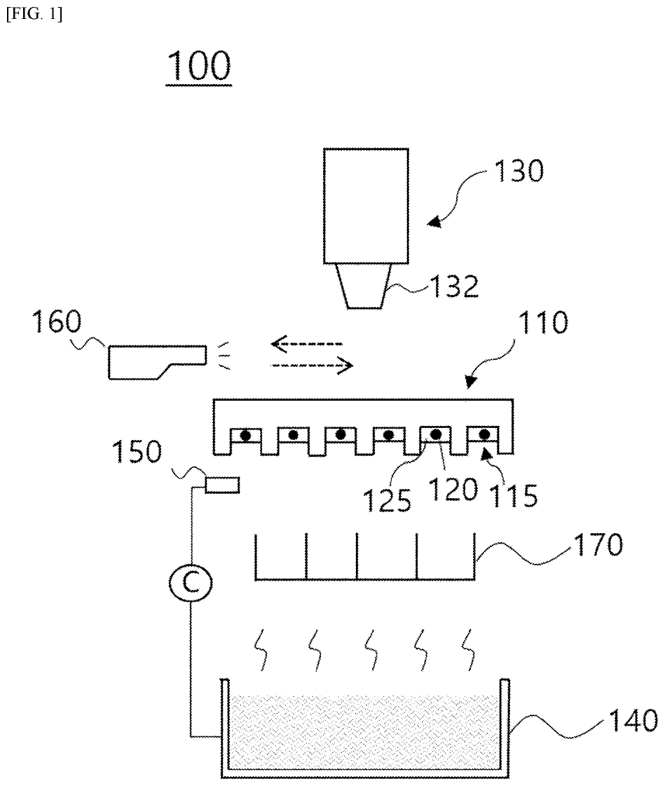

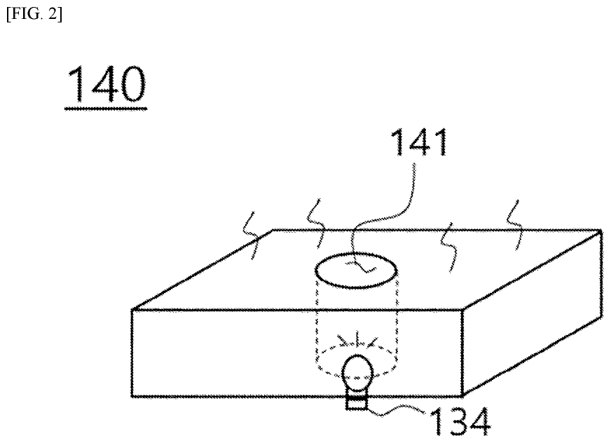

FIG. 1 illustrates an apparatus for separating biological materials according to one embodiment of the present disclosure and FIG. 2 is a perspective view illustrating one embodiment of a water supply unit of the apparatus illustrated in FIG. 1.

Referring to FIGS. 1 and 2, the apparatus 100 includes a substrate 110, biological materials 120, an optical unit 130, a water supply unit 140, and a measurement unit 150.

In one embodiment, the substrate 110 may be a glass, silicon or polymer substrate. Examples of materials for the substrate 110 include slide glass, microbeads, nanoparticles, nanostructures, capillaries, microfluidic supports, porous structures, sponge structures, and dendrimers. The substrate 110 may be a functionalized substrate modified with one or more substances selected from the group consisting of DNA, RNA, proteins, antibodies, and chemicals.

In one embodiment, the substrate 110 may be a substrate including a sacrificial layer, a substrate surface coated with a sacrificial layer, a substrate undergoing a phase transition in the presence of an electromagnetic field or a combination thereof.

Microstructures 115 including a water-bearing medium 125 are arranged on the substrate 110. Here, the water-bearing medium 125 refers to a space where water necessary for survival and growth of the biological materials 120 is retained. This space contains the biological materials 120 together with water. Preferably, the water-bearing medium 125 is supplemented with various nutrients in addition to water to maintain the biological state of the biological materials 120. The water-bearing medium 125 may contain one or more components that are helpful in positionally fixing the biological materials 120 to the substrate 110. Examples of such components include agar, agarose, low melting point agarose, poly-L-lysine, antigens/antibodies, and hydrophilic coating materials. The water-bearing medium 125 may be in the form of a liquid or hydrogel. In one embodiment, the structures 115 may be arranged on the substrate 110 to facilitate attachment or retention of the water-bearing medium 125. Preferably, the structures 115 take the form of structures on a micrometer scale.

In one embodiment, the structures 115 may be designed to facilitate attachment or retention of the water-bearing medium 125. The structures 115 may be, for example, microwells, micropillars, microchannels or micropatterned structures (e.g., wrinkle or grating pattern structures). The structures 115 may be separately patterned and attached to the substrate 110. Alternatively, the structures 115 may be formed integrally with the substrate 110. The structures 115 are usually aligned in an array on the substrate 110. In one embodiment, the structures 115 may be in the form of microwells, as illustrated in FIG. 1.

In FIG. 1, the structures 115 may be arranged on the lower surface of the substrate 110, that is, on the surface of the substrate opposite to the overlying optical unit 130. A capillary or adhesive force can prevent the water-bearing medium 125 from flowing down from the microstructures 115 during observation.

For example, when the structures 115 are in the form of microwells or microchannels, the water-bearing medium 125 containing the biological materials 120 may be accommodated in the wells or channels. Alternatively, the structures 115 may take the form of micropillars. In this case, the biological materials 120 may be immobilized on the substrate 110 by an adhesive force between the surface of the micropillars and the water-bearing medium 125.

The biological materials 120 present in the water-bearing medium 125 can be observed through an observation tool of the optical unit 130 while maintaining their biological state or can be separated from the substrate 110 by application of energy from an extraction tool such as a laser generator of the optical unit 130.

In one embodiment, the biological materials 120 may be animal cells, plant cells, tissues, blood, viruses, bacteria, DNA molecules, RNA molecules or proteins that can maintain their biological state in suitable humidity and temperature environmental conditions. Preferably, the biological materials 120 are those that can be cultured (i.e. are divisible).

The optical unit 130 may include an observation tool for observing the biological materials 120 while maintaining their biological state and an extraction tool for applying energy to the biological materials 120. The biological materials 120 can be separated from the substrate 110 by application of energy from the extraction tool of the optical unit 130.

In one embodiment, the observation tool of the optical unit 130 may consist of one or more optical elements selected from an optical lens, a light source, and an image sensor. For example, the light source may be halogen lamp. The extraction tool of the optical unit 130 may include an energy generator such as a pulsed laser light source and a light concentrator. The light concentrator is preferably an optical lens that can be used for both concentration of pulsed laser energy and observation of the substrate 110. That is, the observation tool and the extraction tool may use the same or separate optical lenses.

In one embodiment, the optical lens may have a magnification in the range of 2× to 100×, preferably 10× to 40×. Within this range, sufficient energy to separate the biological materials 120 can be transmitted to the substrate 110 through the optical lens, and at the same time, the substrate 110 can be prevented from coming into contact with the optical lens or moving away from the focal distance of the optical lens.

In one embodiment, the light source may have a wavelength in the range of 10 to 10,000 nm, preferably 50 to 2,000 nm, more preferably 100 to 1,500 nm. Within this wavelength range, the substrate 110 can be most easily observed with visible light.

In one embodiment, the biological materials 120 may be separated from the substrate 110 by irradiating a pulsed laser onto desired areas of the substrate 110 (for example, the surface of the substrate opposite to the surface on which the target sample is located) through the light concentrator (preferably, an optical lens) of the extraction tool of the optical unit 130.

The extraction tool may be a tool for energy application in a contact or non-contact mode. The contact mode may be, for example, pipetting. The non-contact mode may be, for example, pulsed laser irradiation or ultrasonic application. Preferably, energy is applied in a non-contact mode to separate the biological materials 120 from the substrate 110. The non-contact mode prevents the occurrence of cross-contamination. The image sensor is typically a CCD but is not limited thereto.

Methods for separating samples on substrates using a pulsed laser are specifically disclosed in U.S. Pat. No. 9,328,366 and Korean Patent No. 10-1595159, which were assigned to the present applicant and are incorporated herein by reference. The water supply unit 140 supplies water to replenish water removed from the water-bearing medium 125 by evaporation so that the biological state of the biological materials 120 can be maintained.

In one embodiment, the apparatus 100 may include a separation unit (not illustrated) as an extraction tool for extracting the biological materials 120. The extraction tool is provided separately from the optical unit 130 and is distinguished from the extraction tool of the optical unit 130. In this case, the extraction tool is intended to include a contact type tool for mechanical extraction as well as a non-contact type tool such as a laser generator.

The water-bearing medium 125 refers to a medium essentially containing water and may be, for example, an agar gel mixed with a bacterial culture medium. When the water content of the water-bearing medium 125 is reduced by evaporation, the salt concentration of the culture medium increases, impeding the growth of bacteria, and the agar volume varies, causing modification of the biological materials 120 into difficult-to-observe forms. Accordingly, an appropriate amount of water needs to be replenished.

One surface of the substrate 110 is essentially open such that the biological materials are exposed to the outside. Due to this open structure, the biological materials 120 are easy to separate and collect. If the water-bearing medium 125 is deficient in water by natural evaporation or heating with an external heat source during observation and separation of the biological materials 120 or is outside a suitable temperature range, the appearance and physical properties of the water-bearing medium 125 may be changed, with the result that the biological materials 120 fail to maintain their biological state or are changed to a state that is difficult to observe with the optical unit 130.

In one embodiment, the water supply unit 140 may include a water reservoir and a moisture generator (not illustrated). The water reservoir may be a container for water storage. The moisture generator can supply water from the water reservoir to the atmosphere by heating or sonication. For example, water vapor may be generated by heating with a heat conductor.

In one embodiment, water vapor may be generated by arranging electrodes in the water reservoir, filling water in the water reservoir, and conducting electricity to boil the water. In an alternative embodiment, moisture may be generated by arranging a metal on the bottom of the water reservoir, vibrating the metal to produce ultrasonic waves, and applying the ultrasonic waves to water to allow fine water particles to leap over the water surface. The water vapor generated by heating or the water particles generated by sonication reach the substrate 110 to replenish water removed from the water-bearing medium 125 by evaporation. The water supply unit 140 may further include an air blower for easy supply of water from the water reservoir to the substrate 110, if needed.

The hot water vapor generated by heating can be used to maintain the biological materials 120 at a suitable temperature or to control the biological materials 120 to a required temperature.

In one embodiment, the water supply unit 140 may be interposed between an optical lens 132 and a light source 134. As illustrated in FIG. 2, the water supply unit 140 can be disposed in the axial direction between the optical lens 132 for observation and the light source 134 of the optical unit 130. The water supply unit 140 may have a through-hole 141 through which light from the light source 134 is transmitted. The formation of the through-hole 141 minimizes the influence of the water supply unit 140 on the path of light from the light source 134 to facilitate observation and separation of the biological materials 120 in an efficient manner.

In an alternative embodiment, the water supply unit 140 may be located laterally or in a space off-axis between the optical lens 132 and the light source 134. According to this embodiment, water can be supplied in the direction toward the substrate 110 by diffusion of wet air or using an air blower.

In one embodiment, the water supply unit 140 receives a measured humidity value from the humidity control unit 150, compares the measured humidity value with an ideal humidity value for maintaining the biological state of the biological materials 120, and operates a heater or produces ultrasonic waves to convert water to water vapor so that the measured humidity value can be controlled to the ideal humidity value. The apparatus may further include a temperature measurement unit (not illustrated) to control the temperature to a suitable value together with the humidity control, if needed.

The humidity control unit 150 measures the temperatures and humidities of a space defined between the substrate 110 and the water supply unit 140 at preset time intervals (for example, in real time or at specific times). Thus, a user can receive humidity values calculated from the measured temperatures or the measured humidity values and can control the operation of the water supply unit 140 based on the humidity values such that the amount of water vapor generated is adjusted. Here, the humidity control unit 150 is preferably placed at a location (e.g., under the substrate 110) where the operation of each of the elements is not impeded such that the apparatus 100 operates well.

The apparatus 100 further includes a moisture removal unit 160.

The moisture removal unit 160 removes moisture from a space defined between the substrate 110 and the optical unit 130, which prevents scattering of light and enables efficient observation or separation of the biological materials 120 using only light with an appropriate intensity.

In one embodiment, the moisture removal unit 160 may use a dehumidifying agent to remove very wet air from the space defined between the substrate 110 and the optical unit 130.

In one embodiment, the moisture removal unit 160 may remove moisture using an air intake device to intake very wet air from the space defined between the substrate 110 and the optical unit 130.

In one embodiment, the moisture removal unit 160 may use an air pump for blowing dry air into the space defined between the substrate 110 and the optical unit 130 to lower the humidity of the space. That is, the moisture removal unit 160 can receive water-free dry air and can spray the dry air into the space defined between the substrate 110 and the optical unit 130 to lower the humidity of the space.

The apparatus 100 may further include a collection unit 170.

The collection unit 170 is disposed in a space under the substrate 110 to collect the biological materials 120 separated from the substrate 110.

In one embodiment, the collection unit 170 may include a container (e.g., a plate, a 4/8/32/96/384 well or a microwell) constructed to store the separated biological materials 120 or to monitor a physical or chemical reaction of the biological materials 120.

In one embodiment, the collection unit 170 may also use a transparent plate to optically identify the separated biological materials 120 and to determine a physical reference location of the substrate 110. The collection unit 170 may be in various forms. For example, the collection unit 170 may be an accommodation tool such as a flat-bottom storage container made of a transparent plastic material. Here, the flat bottom of the storage container advantageously reduces the influence on the path of light from the light source 134 to ensure easy imaging.

As is apparent from the foregoing, the apparatus is constructed to provide water to the biological materials through the water supply unit. Due to this construction, the biological materials can maintain their original biological state without loss of water. Thus, the biological materials can be observed on the substrate for a long time even when exposed to the external environment or can be separated from the substrate.

Although the present disclosure has been described herein with reference to the foregoing embodiments, those skilled in the art will appreciate that various modifications can be made to the embodiments, without departing from the spirit and scope of the present disclosure.

1. An apparatus for separating biological materials, comprising:
a substrate on which a water-bearing medium is arranged;
biological materials present in the water-bearing medium;
an observation tool for observing the biological materials; an extraction tool for separating the biological materials from the substrate;
a water supply unit for replenishing water removed from the water-bearing medium by evaporation; and
a humidity control unit for measuring the temperature or humidity in a space defined between the substrate and the water supply unit.

2. The apparatus according to claim 1, wherein structures are arranged on the substrate to facilitate attachment or retention of the water-bearing medium.

3. The apparatus according to claim 1, wherein the observation tool consists of one or more optical elements selected from an optical lens, a light source, and an image sensor.

4. The apparatus according to claim 1, wherein the extraction tool comprises a device for energy application in a contact or non-contact mode.

5. The apparatus according to claim 1, further comprising a moisture removal unit for removing moisture from a space defined between the substrate and the observation tool.

6. The apparatus according to claim 1, wherein the water supply unit comprises a water reservoir and a moisture generator.

7. The apparatus according to claim 1, wherein the water supply unit has a through-hole through which light from a light source is transmitted.

8. The apparatus according to claim 1, wherein the humidity control unit controls the amount of moisture generated from the water supply unit based on the measured temperature or humidity information.
